(19) United States
(12) Patent Application Publication
(10) Pub. No.: US 2010/0245477 A1
(43) Pub. Date: Sep. 30, 2010

(54) Head module, droplet ejection unit, Image forming apparatus, droplet ejection head positioning jig, and method for manufacturing head module

(76) Inventors: Kazunobu Ohkubo, Kanagawa (JP); Keiichi Yagi, Kanagawa (JP)

Correspondence Address: AKERMAN SENTERFITT, 8100 BOONE BOULEVARD, SUITE 700, VIENNA, VA, 22182-2683, US

(21) Appl. No.: 12/659,905

(22) Filed: Mar. 25, 2010

(30) Foreign Application Priority Data
Mar. 31, 2009 (JP) 2009-086862

(51) Int. Cl. B41J 2/14; B25B 27/14; B23P 17/00

(52) U.S. Cl. 347/47; 29/281.4; 29/890.1

(57) ABSTRACT

A head module includes: a droplet ejection head that has a nozzle surface formed by a plurality of nozzles and ejects droplets through the plurality of nozzles; a support plate to which the droplet ejection head is fixed; and a sub-plate to which the support plates are fixed. When a plurality of the support plates are fixed to the sub-plate, the plurality of the support plates are fixed thereto with the nozzle surfaces of the plurality of droplet ejection heads being disposed on the same plane. Consequently, tilts of the nozzle surfaces of the droplet ejection heads can be prevented.

### CROSS-REFERENCE TO RELATED APPLICATION

This application claims priority under 35 USC 119 from Japanese Patent Application No. 2009-086862, filed on Mar. 31, 2009, the disclosure of which is incorporated by reference herein.

### BACKGROUND OF THE INVENTION

1. Field of the Invention

The present invention relates to a head module, a droplet ejection unit, an image forming apparatus, a droplet ejection head positioning jig, and a method for manufacturing a head module.

2. Description of the Related Art

An image forming apparatus, which has droplet ejection heads in which nozzle surfaces for ejecting droplets of ink or the like onto a recording medium are formed, is conventionally known. A method for manufacturing a head module is disclosed in which droplet ejection heads are assembled to a carriage that is movable in a direction orthogonal to a direction in which a recording medium is conveyed, wherein the droplet ejection heads are assembled to the carriage after a board is mounted to each of the droplet ejection heads that are in the shape of cuboids, and positioning of the droplet ejection heads is performed by adjusting the positions of the boards using a jig. (See, for example, Japanese Patent Application Laid-Open (JP-A) No. 2003-246072.)

In the method for manufacturing a head module disclosed in JP-A No. 2003-246072, positioning of the droplet ejection head is performed such that the board is moved with a pin of a main body of a plate-shaped jig of a positioning device being inserted into a hole formed in the board. The main body of the jig is formed in a substantial U-shape and brought into contact with side surfaces of the droplet ejection head to prevent misalignment of the droplet ejection heads in a lateral direction.

Although the structure disclosed in JP-A No. 2003-246072 uses the U-shaped main body of the jig to prevent misalignment of the droplet ejection head toward the side surface thereof, this structure does not prevent the tilt of an upper surface of the droplet ejection head. Thus, when the plural droplet ejection heads are assembled to the carriage, the respective nozzle surfaces are tilted differently along surfaces of portions of the carriage to which the droplet ejection heads are mounted. Aligning the nozzle surfaces in order to prevent tilts thereof has been difficult.

### SUMMARY OF THE INVENTION

The present invention provides a head module, a droplet ejection unit, an image forming apparatus, a droplet ejection head positioning jig and a method for manufacturing a head module, by which tilts of nozzle surfaces of the droplet ejection unit can be prevented.

The head module according to a first aspect of the invention includes: a droplet ejection head that has a nozzle surface on which a plurality of nozzles are formed and ejects droplets through the plurality of nozzles; a support member to which the droplet ejection head is fixed; and a sub-plate incorporated in a droplet ejection device and to which the support members are fixed with nozzle surfaces of droplet ejection heads being disposed on the same plane of a reference plate.

In the head module according to the first aspect of the invention, the droplet ejection head having the plurality of nozzles for ejecting droplets is fixed to the support member. When a plurality of the support members are mounted on the sub-plate, since the support members are fixed to the sub-plate with the nozzle surfaces of the plurality of droplet ejection heads being disposed on the same plane, i.e., a common plane serving as a reference surface, tilting of the nozzle surfaces of the droplet ejection heads can be prevented.

In the head module according to the first aspect of the invention, a screw hole may be formed in the support member, and a screw for connecting a reference plate to the support plate may be inserted into the screw hole such that the nozzle surface is brought into contact (surface contact) with the reference plate. According to this structure, the nozzle surface of the droplet ejection head is brought in contact with the reference plate when the screw is tightened into the screw hole in the support member to connect the reference plate thereto. By forming the screw hole in the support member in this way, the support members are fixed to the sub-plate with the nozzle surfaces of the plurality of droplet ejection heads being disposed on the same plane. Consequently, tilts of the nozzle surfaces of the droplet ejection heads can be prevented.

In the head module according to the first aspect of the invention, a groove, into which a hitching member provided at the reference plate that is brought into contact with the nozzle surface is hitched, is formed at a side surface of the support member. According to this structure, by the hitching member of the reference plate being hitched into the groove formed at the side surface of the support member, the support member is positioned relative to the reference plate, and the nozzle surface is brought into contact with the reference plate. By forming the groove at the side surface of the support member, the support plates are fixed to the sub-plate with the nozzle surfaces of the plurality of droplet ejection heads being disposed on the same plane. Consequently, tilts of the nozzle surfaces of the droplet ejection heads can be prevented.

In a droplet ejection unit according to a second aspect of the invention, a mounting surface is formed, to which the sub-plate of the head module according to the first aspect of the invention is mounted such that the nozzle surface is parallel to a surface onto which droplets are ejected. According to this structure, since the sub-plate is mounted to the mounting surface of the droplet ejection unit such that the plurality of nozzle surfaces disposed on the same plane are parallel to the surface onto which droplets are ejected, the position at which droplets are ejected from the droplet ejection unit can be set to a desired position on the surface onto which droplets are ejected.

An image forming apparatus according to a third aspect of the invention includes the droplet ejection unit according to the second aspect of the invention, and a drive unit that drives the droplet ejection unit to eject droplets from the nozzle surface onto a recording medium such that an image is formed on the recording medium that has been conveyed to the surface onto which droplets are ejected. According to this structure, droplets are ejected from the nozzle surface of the droplet ejection unit driven by the drive unit, such that an image is formed on the recording medium. Since the position at which droplets are ejected from the droplet ejection unit is a desired position on the recording medium, which is the surface onto which droplets are ejected. Thus, misregistration of images formed on the recording medium can be prevented.

A droplet ejection head positioning jig according to a fourth aspect of the invention is for positioning and fixing a support member to a sub-plate incorporated in a droplet ejection device, the support member having fixed thereto a droplet ejection head that has a nozzle surface on which a plurality of nozzles are formed and ejects droplets through the plurality of nozzles, the droplet ejection head positioning jig including: a frame member; a reference plate disposed on an upper surface of the frame member; a retaining structure for retaining the support member and bringing the nozzle surface into surface contact with the reference plate; and a movable stage for moving the reference plate.

According to the above structure, first, the frame member is disposed so as to surround the plurality of droplet ejection heads and side surfaces of the support members. Subsequently, the reference plate is placed on the upper surface of the frame member, and the retaining structure (means) retains the support member while the nozzle surface is brought into contact with the reference plate. Thereafter, the reference plate is moved in an in-plane direction by the movable stage, whereby positioning of the droplet ejection head is performed. In this way, positioning of the droplet ejection head can be performed while the nozzle surface is brought into contact with the reference plate. As a result, tilts of the nozzle surfaces of the droplet ejection heads can be prevented.

In the droplet ejection head positioning jig according to the fourth aspect of the invention, the frame member may be fixed to the sub-plate at three points. According to this structure, since the frame member is fixed to the sub-plate at three points, the support points of the sub-plate are formed on the same plane. Thus, stable posture reproduction can be achieved without being affected by the accuracy of the plane of the sub-plate.

A method for manufacturing a head module according to a fifth aspect of the invention, which head module includes droplet ejection heads, each of which has a nozzle surface on which a plurality of nozzles are formed and ejects droplets through the plurality of nozzles, support members to which the droplet ejection heads are respectively fixed, and a sub-plate incorporated in a droplet ejection device and to which the support members are fixed, the method including: disposing a plurality of nozzle surfaces on the same plane and positioning the support members with the support members being apart from the sub-plate; and attaching the support members to the sub-plate after the positioning.

In the above method, the support members having the droplet ejection heads fixed thereto are fixed to the sub-plate with the nozzle surfaces of the droplet ejection heads being disposed on the same plane, whereby tilts of the nozzle surfaces of the droplet ejection heads can be prevented.

With the above structure, the invention can prevent tilts of the nozzle surfaces of the droplet ejection heads.

### BRIEF DESCRIPTION OF THE DRAWINGS

FIG. 1 is an overall view of an image forming apparatus according to a first embodiment of the invention;

FIG. 2A is a bottom view of a droplet ejection unit according to the first embodiment of the invention;

FIG. 2B is a cross-sectional view (taken through the line A-A′ in FIG. 2A) of the droplet ejection unit according to the first embodiment of the invention;

FIG. 3A is a transparent plan view showing the structure of the droplet ejection unit according to the first embodiment of the invention;

FIG. 3B is a cross-sectional view of a nozzle of a droplet ejection head according to the first embodiment of the invention;

FIG. 4 is a perspective view of a head module according to the first embodiment of the invention that is set in a droplet ejection head positioning jig;

FIGS. 5A and 5B are a plan view and a cross-sectional view, respectively, of the head module according to the first embodiment of the invention that is set in the droplet ejection head positioning jig;

FIG. 6 is a perspective view showing a state in which a frame member of the droplet ejection head positioning jig is mounted onto a sub-plate according to the first embodiment of the invention;

FIGS. 7A-7C are process drawings showing the step of setting the droplet ejection head, a support member and the sub-plate according to the first embodiment of the invention on the droplet ejection head positioning jig;

FIGS. 8A-8C are process drawings showing the step of bringing the surface of the nozzle into contact with a reference plate of the droplet ejection head positioning jig according to the first embodiment of the invention and securing the support member to the sub-plate;

FIG. 9A is a cross-sectional view of a droplet ejection unit according to a comparative example with respect to the invention;

FIG. 9B is a cross-sectional view (taken through the line B-B′ in FIG. 2A) of the droplet ejection unit according to the first embodiment of the invention;

FIGS. 10A and 10B are structural diagrams showing another example of the droplet ejection head positioning jig according to the first embodiment of the invention;

FIG. 11A is a side view of a droplet ejection unit according to a second embodiment of the invention;

FIG. 11B is an explanatory view showing the structure of a retaining means of a droplet ejection head positioning jig according to the second embodiment of the invention;

FIGS. 12A and 12B are process drawings showing the step of setting a droplet ejection head, a support member and a sub-plate according to the second embodiment of the invention on the droplet ejection head positioning jig;

FIGS. 13A and 13B are process drawings showing the step of bringing the surface of the nozzle into contact with a reference plate of the droplet ejection head positioning jig according to the second embodiment of the invention so that the nozzle surface is retained thereby; and

FIGS. 14A and 14B are structural diagrams showing first and second alternative examples, respectively, of the droplet ejection head according to the second embodiment of the invention.

### DETAILED DESCRIPTION OF THE INVENTION

A first embodiment of a head module, a droplet ejection unit, an image forming apparatus, a droplet ejection head positioning jig, and a method for manufacturing a head module in accordance with the invention will be described with reference to the drawings.

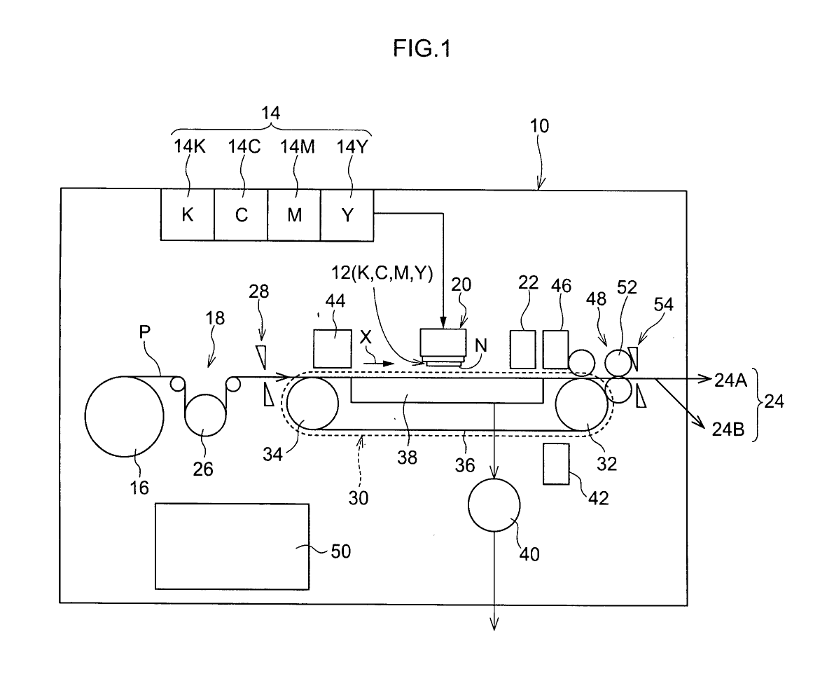

FIG. 1 shows an inkjet recording apparatus 10 that corresponds to the image forming apparatus according to the first embodiment of the invention. The inkjet recording apparatus 10 has a printing unit 20, which includes plural head modules 12 (12K, 12C, 12M and 12Y) provided so as to correspond to inks of black (K), cyan (C), magenta (M) and yellow (Y), respectively.

Ink tanks 14 (14K, 14C, 14M and 14Y) having inks (droplets) of the respective colors stored therein are connected to the respective head modules 12K, 12C, 12M and 12Y via supply tubes (not shown), such that inks are supplied from the ink tanks 14K, 14C, 14M and 14Y to the head modules 12K, 12C, 12M and 12Y, respectively.

The inkjet recording apparatus 10 further includes a sheet feed unit 16, a decurl unit 18, a belt conveyance unit 30, a print detection unit 22 and a sheet discharging unit 24. The sheet feed unit 16 feeds a recording sheet P serving as a recording medium. The decurl unit 18 removes curls of the recording sheet P. The belt conveyance unit 30 is disposed so as to face a nozzle surface N of the print unit 20 and conveys the recording sheet P while maintaining flatness thereof. The print detection unit 22 reads the results of printing performed by the printing unit 20. The sheet discharging unit 24 discharges out the recording sheet P that has been subjected to recording. The term “print/printing” as mentioned herein refers to printing of images as well as printing of characters.

The sheet feed unit 16 is structured such that the recording sheet P in the form of a roll is rotated and conveyed to the downstream side. The recording sheet P thus conveyed reaches the decurl unit 18. The decurl unit 18 includes a heating drum 26 that is heated by a heating source such as a heater. The recording sheet P that has reached the decurl unit 18 is decurled by being heated by the heating drum 26 in a direction opposite to the direction in which the recording sheet P tends to curl.

A cutter 28 is disposed at the downstream side of the decurl unit 18 in a direction in which the recording sheet P is conveyed (i.e., in the direction of arrow X). The cutter 28 cuts the roll-shaped recording sheet P into the desired size. The cutter 28 is unnecessary when a cut sheet is used as the recording sheet P. After the decurling, the recording sheet P that has been cut is conveyed downstream to the belt conveyance unit 30.

The belt conveyance unit 30 includes a drive roller 32, which is rotatable and driven by a motor or the like, and a driven roller 34, which is disposed so as to be rotatable and parallel to the drive roller 32. Further, the belt conveyance unit 30 is structured so that an endless conveyance belt 36 is wound around the drive roller 32 and the driven roller 34. The conveyance belt 36 is driven clockwise in FIG. 1, whereby the recording sheet P held thereon is conveyed from left to right.

The conveyance belt 36 is of a width greater than that of the recording sheet P, and a number of suction holes (not shown) are formed in the conveyance belt 36. A suction chamber 38 in which negative pressure is generated for suction is disposed inside the conveyance belt 36 at a position opposing the surfaces N of nozzles of the print unit 20 and the surface of a sensor of the print detection unit 22. By the suction chamber 38 being sucked by a fan 40 so that negative pressure is generated inside the suction chamber 38, the recording sheet P is sucked via the suction holes and held on the conveyance belt 36. An electrostatographic suction method, in which suction is performed by energization, may be used in place of the above suction method.

A belt cleaning unit 42 in the shape of a brush or a roll is disposed at a predetermined position outside the conveyance belt 36 (an appropriate position other than a printing area) so as to remove contamination on the surface of the conveyance belt 36. Further, a heating fan 44 is disposed upstream of the printing unit 20 on a sheet conveyance path formed by the belt conveyance unit 30. The heating fan 44 blows heated air onto the recording sheet P before printing to heat the recording sheet P. Heating the recording sheet P immediately before printing facilitates drying of ink that has adhered to the recording sheet P.

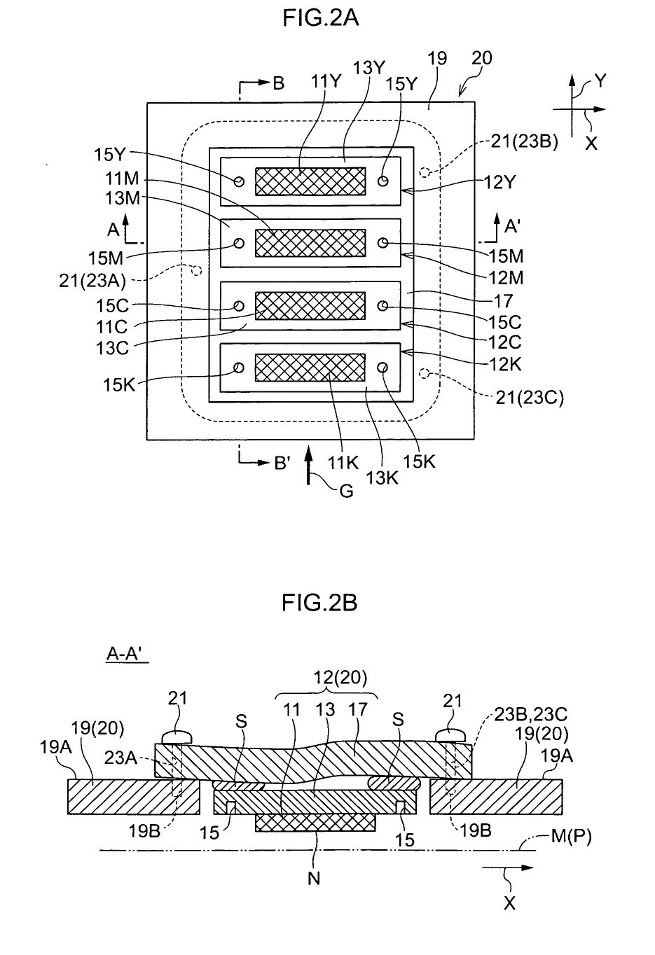

As shown in FIG. 2A, the head modules 12K, 12C, 12M and 12Y of the printing unit 20 are mounted on a carriage 19. The carriage 19 is cuboid and has through holes (not shown) formed therein. Guide rails (not shown), which are disposed parallel to a main scanning direction (i.e., the direction of arrow Y) that is orthogonal to the conveying direction of the recording sheet P (i.e., the direction of arrow X), are inserted into the through holes. The carriage 19 is driven by a drive means (not shown) such as a motor so as to reciprocate along the guide rails in the main scanning direction. In this way, the printing unit 20 of a shuttle type is formed.

Further, the head modules 12K, 12C, 12M and 12Y are disposed in the order of the colors of black (K), cyan (C), magenta (M) and yellow (Y) along the main scanning direction. As shown in FIG. 1, in the inkjet recording apparatus 10, a color image is formed on the recording sheet P by the head modules 12K, 12C, 12M and 12Y ejecting inks of different colors while the recording sheet P is conveyed by the belt conveyance unit 30.

The print detection unit 22 includes an image sensor (a line sensor or an area sensor) that captures the results of ink droplets spotted by the printing unit 20, and serves as a means for checking, based on an image formed by spotting ink droplets, which image has been read by the image sensor, ejection characteristics such as clogs of the nozzles or errors in the positions of spotting. Data on the conditions of printing detected by the print detection unit 22 (such as the presence of ejection, errors in the positions of spotting, the shape of dots, optical density and the like) are transmitted to and stored in a control unit 50, which controls operation of the respective units of the inkjet recording apparatus 10. The control unit 50 drives the printing unit 20 on the basis of the image data such that the printing unit 20 ejects inks from the nozzle surfaces N onto the recording sheet P.

A post-drying unit 46 is disposed downstream of the print detection unit 22 in the conveying direction of the recording sheet P. The post-drying unit 46 is a means for drying the surface of the image printed on the recording sheet P and, for example, a heating fan is used as the post-drying unit 46. The hot-air drying method is preferable since contact with the surface of the recording sheet P having the image printed thereon should be avoided until the inks on the surface of the recording sheet P dry after printing.

A glossiness control means (device) 48 is disposed downstream of the post-drying unit 46 in the conveying direction of the recording sheet P. The glossiness control means 48 is a means for controlling the glossiness of the surface of the image on the recording sheet P and has a pair of pressure rollers 52 and a heating means (not shown) such as a heater. The glossiness control means 48 heats the surface of the image on the recording sheet P while applying pressure thereto using the pressure rollers 52 that have irregular surfaces. In this way, the glossiness control means 48 transfers the irregular shapes of the surfaces of the pressure rollers 52 to the image surface and changes the glossiness thereof.

The recording sheet P on which the image has been thus formed is discharged to the sheet discharging unit 24. It is preferable to separately discharge a print of the image to be formed (i.e., a print having the desired image formed thereon) and a test print. For this reason, the inkjet recording apparatus 10 includes a sort means (mechanism) (not shown) for sorting a print of the desired image and a test print and switching between discharge paths leading to discharging ports 24A and 24B, respectively.

When the desired image and an image for test printing are formed side-by-side on a large recording sheet P, the portion of the recording sheet P on which the image for test printing is formed is cut off by a cutter 54 disposed downstream of the pressure rollers 52. Further, although not illustrated, a sorter for accumulating prints for every printing instruction is disposed at the discharging port 24A for prints of the desired images.

The structure of the printing unit 20 will be described next. Since the head modules 12K, 12C, 12M and 12Y have a common structure, the letters K, C, M and Y are omitted unless it is necessary to distinguish the respective colors from one another.

FIG. 2A is a plan view of the printing unit 20, and FIG. 2B is a cross-sectional view of the printing unit 20 as seen in the direction of arrow G in FIG. 2A. As shown in FIGS. 2A and 2B, the printing unit 20 includes the head modules 12 (12K, 12C, 12M and 12Y) and the carriage 19 having the head modules 12K, 12C, 12M and 12Y mounted thereon.

The head module 12 includes an ink ejection head 11, a support plate 13 and a sub-plate 17. The ink ejection head 11 is disposed so as to oppose an image forming surface M of the recording sheet P and ejects supplied ink toward the image forming surface M. The support plate 13 has the ink ejection head 11 fixed thereto at the upper surface and thereby supports the ink ejection head 11. The sub-plate 17 has the support plate 13 fixed thereto via an adhesive S and is secured to a mounting surface 19A (upper surface) of the carriage 19 by three screws 21.

The ink ejection heads 11 (11K, 11C, 11M and 11Y) and the support plates 13 (13K, 13C, 13M and 13Y) are disposed on the sub-plate 17 in the order of K, C, M and Y in the main scanning direction.

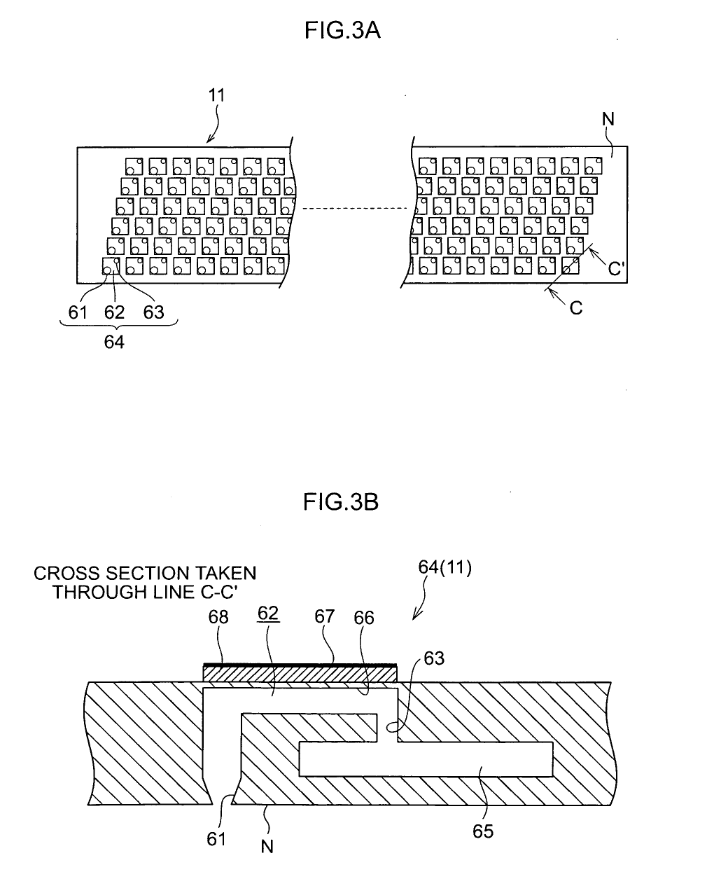

As shown in FIG. 3A, the ink ejection head 11 is structured such that plural ink chamber units (droplet ejection elements) 64, each of which include a nozzle 61 serving as an ink outlet, a pressure chamber 62 communicating with the nozzle 61, and an ink supply channel 63, through which ink to be supplied to the pressure chamber 62 flows, are disposed in a staggered configuration, namely, in the form of a matrix (in two dimension). With this structure, the ink ejection head 11 achieves substantially high density of nozzles that are projected so as to be arranged along a longitudinal direction of the head (i.e., in the conveying direction of the recording sheet P).

The pressure chamber 62 provided so as to correspond to each of the nozzles 61 has a substantially square plane surface. An ink flow channel to the nozzle 61 is provided at one of diagonally opposite corners of the pressure chamber 62, while the ink supply channel 63 is provided at the other. The shape of the pressure chamber 62 is not limited to that shown in the present embodiment, and the pressure chamber 62 may have a plane surface of various shapes such as a quanrangle (such as a rhombus or a rectangle), a pentagon, a hexagon, other polygons, a circle, an oval and the like.

As shown in FIG. 3B, the pressure chamber 62 of each of the ink chamber units 64 communicates with a common channel 65 via the ink supply channel 63. The common channel 65 communicates with the ink tank 14 serving as an ink supply source (see FIG. 1). Ink supplied from the ink tank 14 is distributed to the respective pressure chambers 62 through the common channel 65.

Further, an actuator 68, which is comprised of piezoelectric elements using a piezoelectric substance such as lead zirconate titanate or barium titanate and includes a separate electrode 67, is joined to a pressure plate 66 (i.e., a diaphragm also used as a common electrode) that forms a part of the surface (top surface) of the pressure chamber 62 in the ink chamber unit 64. Applying a drive voltage between the separate electrode 67 and the common electrode 66 deforms the actuator 68 and changes the volume of the pressure chamber 62, whereby the pressure in the pressure chamber 62 is changed and ink is ejected from the nozzle 61.

When the actuator 68 is restored to its original shape after ink is ejected, the pressure chamber 62 is again filled with ink flowing from the common channel 65 through the ink supply channel 63. Ink droplets can be ejected from the nozzle 61 by controlling driving of the actuator 68 so as to correspond to each nozzle 61 in accordance with dot arrangement data generated on the basis of image information. A desired image can be recorded on the recording sheet P by conveying the recording sheet P at a predetermined speed in a sub-scanning direction (i.e., the direction of arrow X in FIG. 1) while controlling the timing of ink ejection from the nozzle 61 in accordance with the conveying speed. In the present embodiment, the sub-scanning direction refers to the conveying direction of the recording sheet P, and the main scanning direction refers to the direction orthogonal to the sub-scanning direction.

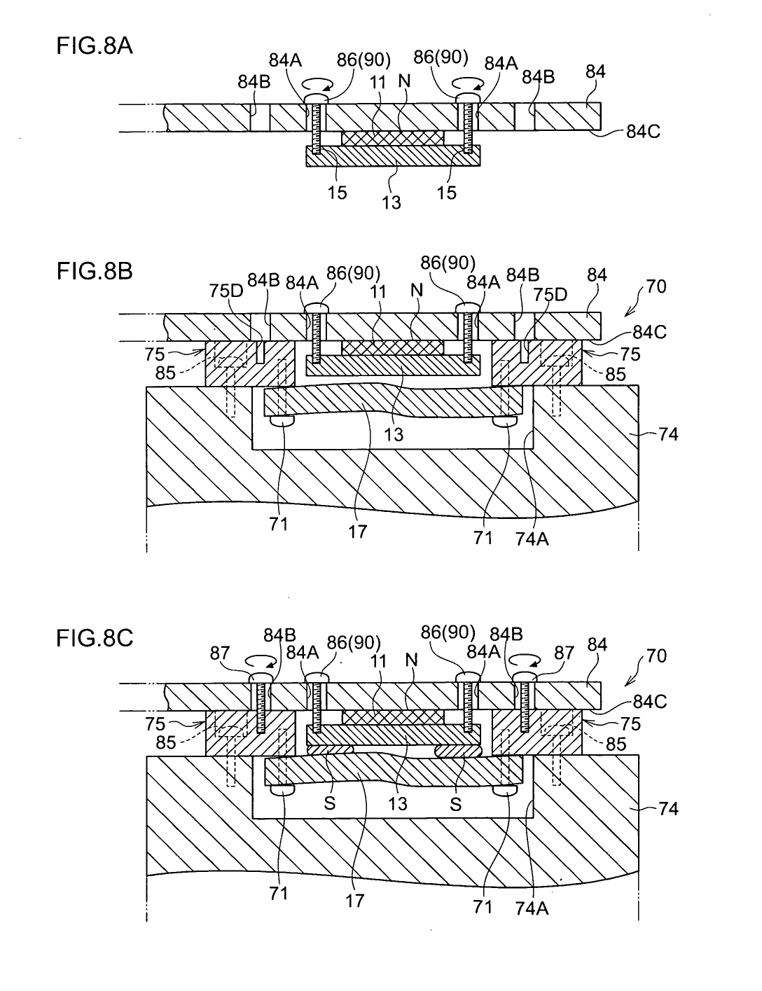

As shown in FIGS. 2A and 2B, a threaded bore 15 is formed at the surface of the support plate, on which the ink ejection head 11 is attached, at each side of the ink ejection head 11 in the sub-scanning direction (the direction of arrow X). The threaded bore 15 is formed so as to correspond to the positions and diameters of a screw 86 for nozzle surface contact and a through hole 84A (see FIG. 8A) of an ink ejection head positioning jig 70, which will be described later. The threaded bore 15 does not penetrate the support plate 13 and has a bottom.

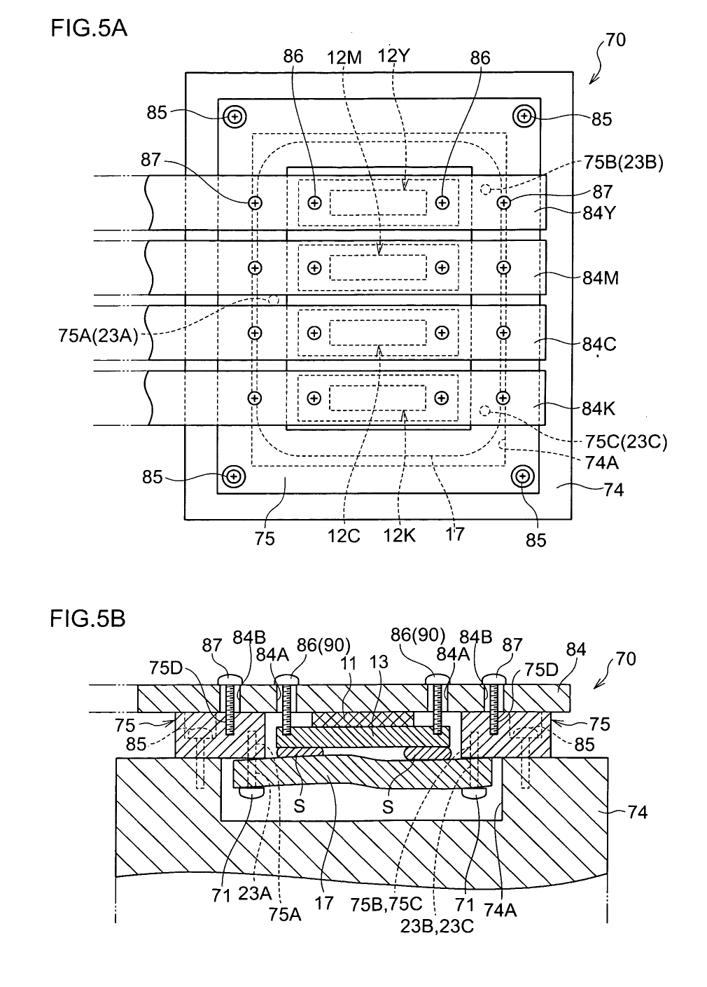

Through holes 23A, 23B and 23C are formed in the sub-plate 17 so as to correspond to the positions and diameters of mounting holes 75A, 75B and 75C (see FIG. 5B), respectively, of a frame member 74 of the ink ejection head positioning jig 70, which will be described later. The sub-place 17 is secured to the carriage 19 by tightening the screws 21 into the mounting surface 19A of the carriage 19 in a state in which three screw holes 19B formed in correspondence with the diameter of the screw 21 and the positions of the through holes 23A, 23B and 23C communicate with the through holes 23A, 23B and 23C.

The carriage 19 is provided so as to be movable in the sub-scanning direction (the direction of arrow X) as described above, and includes the mounting surface 19A on which the sub-plate 17 is mounted in such a manner that the nozzle surface N is parallel to the image forming surface M of the recording sheet P serving as a surface onto which droplets are ejected. In the present embodiment, the sub-plate 17 is mounted to the mounting surface 19A after adjustment of the inclination angle thereof by a jig such that the nozzle surface N is parallel to the image forming surface M. The mounting structure, however, is not limited to this and, for example, the carriage 19 may be mounted to a base that is tilt adjustable such as a gonio-stage, and the base may be tilted after the head module 12 is mounted to the carriage 19 such that the nozzle surface N and the image forming surface M are parallel to each other.

The ink ejection head positioning jig 70 will be described next.

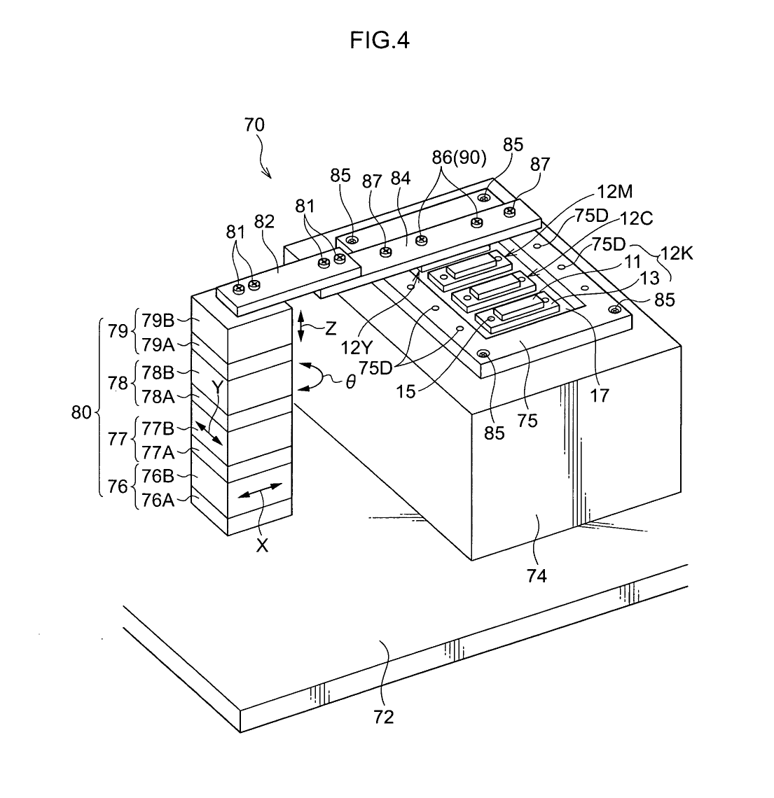

As shown in FIG. 4, the ink ejection head positioning jig 70 has a base member 72 in the shape of a plate placed on an unillustrated surface plate. A cuboid mount 74, on which the frame member 75 having the sub-plate 17 mounted thereon is placed and fixed, is disposed on the base member 72. Plural screw holes (not shown) are formed at an upper surface of the mount 74 such that the sub-plate 17 is secured to the mount 74 by tightening frame member securing screws 85 into the screw holes after the frame member 75 is placed on the mount 74. Further, a recess 74A (see FIG. 5B) accommodating the sub-plate 17 so that the sub-plate 17 and the mount 74 do not contact each other is formed at an upper portion of the mount 74.

An adjusting stage 80 that adjusts the position of the ink ejection head 11 is formed upright on the base member 72 near the mount 74. The adjusting stage 80 is formed by an x-axis adjusting stage 76, a y-axis adjusting stage 77, a gonio-stage 78 and a z-axis adjusting stage 79 that are stacked on the base member 72 in this order.

The x-axis adjusting stage 76 is formed by a base portion 76A, which is plate-shaped and secured to an upper surface of the base member 72 with screws, and a movable portion 76B placed on the base portion 76A. The movable portion 76B can be moved in the sub-scanning direction of the head module 12 (the direction of arrow X) by turning an adjustment knob (not shown).

The y-axis adjusting stage 77 is formed by a base portion 77A, which is plate-shaped and secured to an upper surface of the movable portion 76B of the x-axis adjusting stage 76 with screws, and a movable portion 77B placed on the base portion 77A. The movable portion 77B can be moved in the main scanning direction of the head module 12 (the direction of arrow Y) by turning an adjustment knob (not shown).

The gonio-stage 78 is formed by a base portion 78A, which is plate-shaped and secured to an upper surface of the movable portion 77B of the y-axis adjusting stage 77 with screws, and a movable portion 78B placed on the base portion 78A. The movable portion 78B can be moved in an in-plane direction (the direction of arrow θ) by turning an adjustment knob (not shown).

The z-axis adjusting stage 79 is formed by a base portion 79A, which is secured to an upper surface of the movable portion 78B of the gonio-stage 78 with screws, and a movable portion 79B placed on the base portion 79A. The movable portion 79B can be moved in the direction of a z-axis (the direction orthogonal to arrows X and Y) by turning an adjustment knob (not shown).

A plate-shaped arm member 82 is fixed to the upper surface of the movable portion 79B of the z-axis adjusting stage 79 with screws 81 above the mount 74. An end portion of the arm member 82 (that is opposite the end portion fixed to the adjusting stage 80) is fixed to a reference plate 84 with the screws 81, whereby the reference plate 84 is movable in the in-plane direction (the directions of arrows X, Y and θ) and the z-axis direction. Even if the z-axis adjusting stage 79 is not provided, positioning of the ink ejection head 11 using the reference plate 84 is possible.

Two through holes 84A and two through holes 84B (see FIG. 8A) are formed in the reference plate 84 in a symmetrical arrangement, and the screws 86 for nozzle surface contact, which serve as a retaining means, are inserted into the through holes 84A. The length and positions of the screws 86 for nozzle surface contact are determined such that the screws 86 for nozzle surface contact can be tightened into the screw holes 15 of the support plate 13 of the head module 12. A fixation screw 87 for fixing the reference plate 84 to the frame member 75 is inserted into the through hole 84B. The reference plate 84 is fixed to the frame member 75 by the fixation screw 87 being tightened into a mounting hole 75D of the frame member 74.

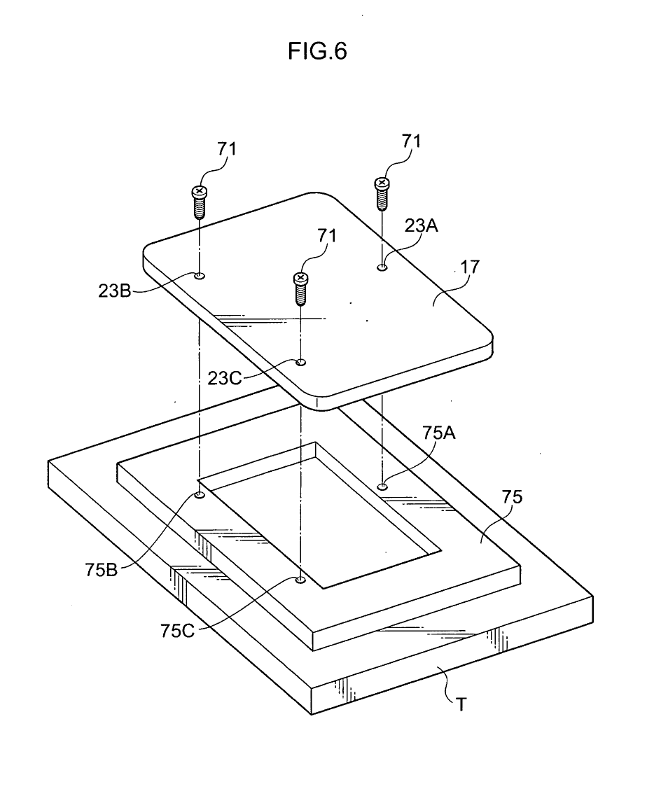

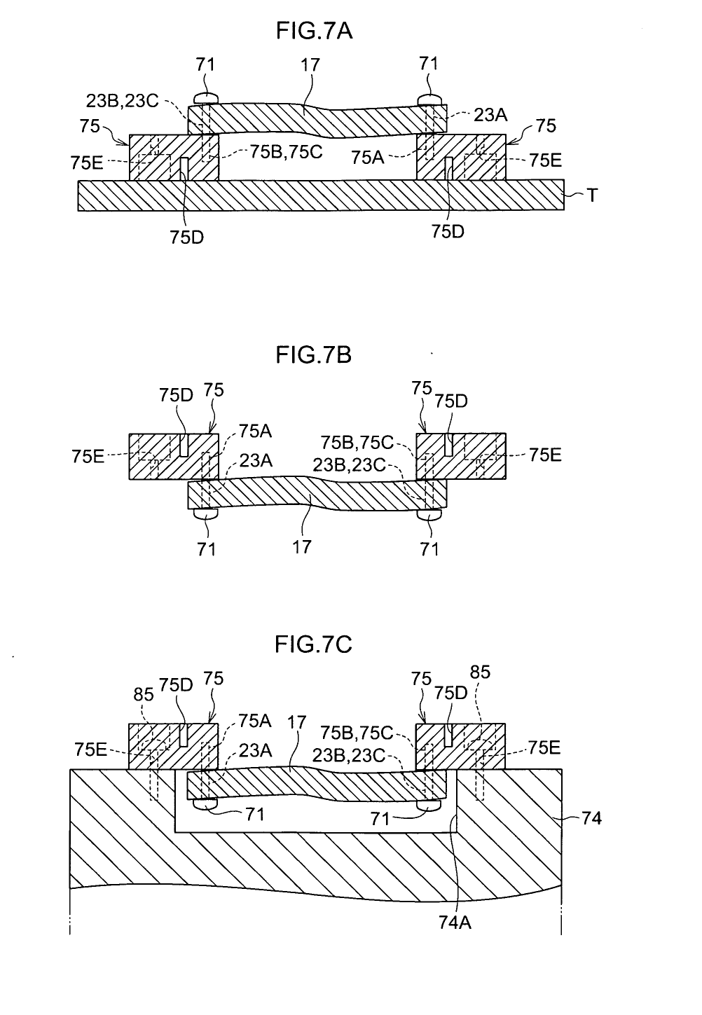

As shown in FIGS. 4 to 6, the frame member 75 is mounted on the sub-plate 17 so as to surround the four ink ejection heads 11 and the four support plates 13. Three mounting holes 75A, 75B and 75C that have threads and do not pass through the frame member 85 are formed at three locations on an undersurface side of the frame member 75, and plural mounting holes 75D are formed at an upper surface side of the frame member 75. The positions and diameter of the mounting holes 75A, 75B and 75C are determined such that the mounting holes 75A, 75B and 75C can communicate with through holes 23A, 23B and 23C formed in the sub-plate 17, respectively. Further, a through hole 75E (see FIG. 7), into which a frame member fixing screw 85 is inserted, is formed in the frame member 75 at four locations (four corners in plan view) thereof.

As shown in FIG. 5A, the surfaces of the head modules 12K, 12C, 12M and 12Y contact the reference plates 84K, 84C, 84M and 84Y, respectively, and the head modules 12K, 12C, 12M and 12Y are held thereby. The head modules 12K, 12C, 12M and 12Y are separately adjusted by the four adjusting stages 80 to which the respective reference plates 84K, 84C, 84M and 84Y are mounted. Since the head modules 12K, 12C, 12M and 12Y have the same structure, positioning of one of the head modules 12 using one of the adjusting stages 80 as shown in FIG. 4 will be described, and description of the other three head modules 12 will be omitted.

The positioning and attaching steps in the method for manufacturing the head module 12 will be described next.

As shown in FIG. 7A, first, the frame member 75 is turned over and placed on a jig plate T. Further, the sub-plate 17 is placed on the frame member 75 such that the mounting holes 75A, 75B and 75C communicate with the through holes 23A, 23B and 23C of the sub-plate 17, respectively. The frame member 75 is mounted to the sub-plate 17 by tightening the screws 71, respectively.

Subsequently, as shown in FIGS. 7B and 7C, the sub-plate 17 and the frame member 75 are turned over so that the frame member 75 is on top of the sub-plate 17, and the frame 75 is fixed to the mount 74 with the frame member fixing screws 85. The sub-plate 17 is disposed in the recess 74A of the mount 74 so that it does not contact the mount 74.

Thereafter, as shown in FIG. 8A, the support plate 13 is fixed to the reference plate 84 with the screws 86 for nozzle surface contact with the nozzle surface N of the ink ejection head 11 contacting a reference surface (undersurface) 84C of the reference plate 84. In this way, the ink ejection head 11 and the support plate 13 are retained by the screws 86 for nozzle surface contact. The reference plate 84 is then fixed to the arm member 82 (see FIG. 4) with the screws 81.

The ink ejection head 11 is fixed to the support plate 13 in advance. Further, the screws 86 for nozzle surface contact are tightened into the screw holes 15 using a torque driver (not shown), the torque of which is set in advance so that the reference surface (undersurface) 84C of the reference plate 84 and the nozzle surface N contact each other when the screws 86 for nozzle surface contact are completely tightened. The contact of the reference surface 84C with the nozzle surface N should be visually confirmed.

Subsequently, as shown in FIGS. 4 and 8B, the height of the reference plate 84 is adjusted by the z-axis adjusting stage 79, and the reference plate 84 is placed on the upper surface of the frame member 75 so that the support plate 13 is placed inside the frame member 75. Positioning of the ink ejection head 11 (the head module 12) is performed using the x-axis adjusting stage 76, the y-axis adjusting stage 77 and the gonio-stage 78 of the adjusting stage 80 with the ink ejection head 11 and the support plate 13 being retained.

Thereafter, as shown in FIG. 8C, after the reference plate 84 is fixed to the frame member 75 with the fixation screws 87, the adhesive S is applied to a space between the support plate 13 and the sub-plate 17. The adhesive S is hardened after the above steps are sequentially carried out on the respective ink ejection heads 11K, 11C, 11M and 11Y. Thereafter, the screws 86 for nozzle surface contact and the screws 71 are then removed to detach the reference plate 84 and the frame member 75. The steps of positioning and attaching the head modules 12 are thus completed.

Subsequently, as shown in FIG. 2B, the sub-plate 17 is fixed to the carriage 19 with the screws 21 to complete the printing unit 20.

Operation of the first embodiment of the invention will be described next.

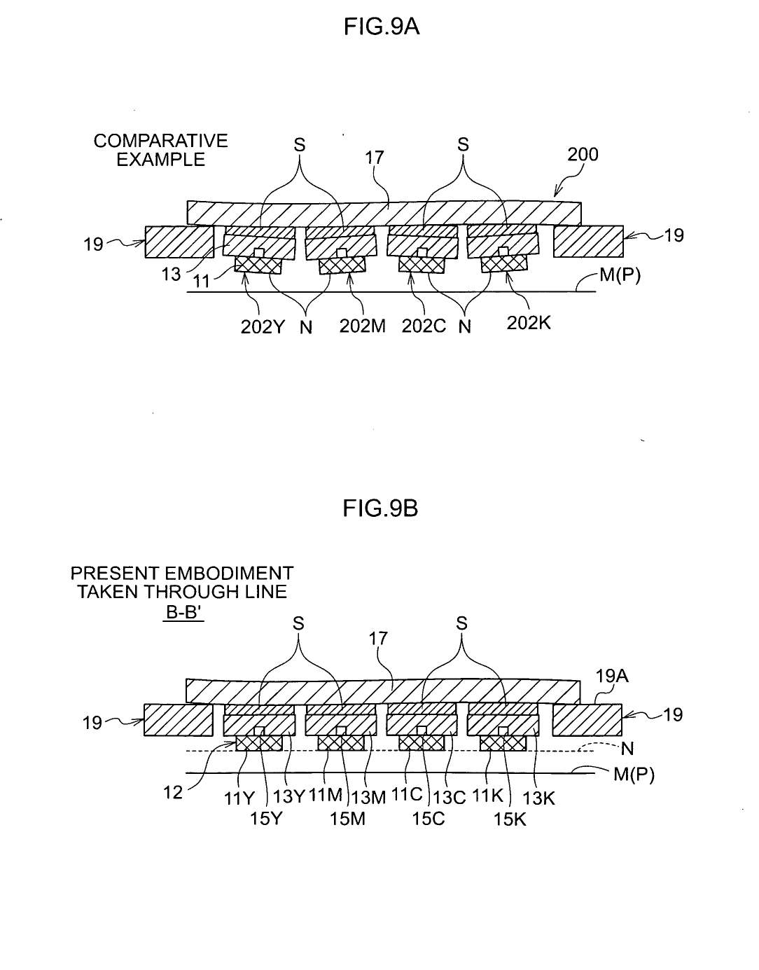

A printing unit 200 is shown in FIG. 9A as a comparative example with respect to the invention. The printing unit 200 includes head modules 202Y, 202M, 202C and 202K. The head modules 202Y, 202M, 202C and 202K are the same as the head modules 12K, 12C, 12M and 12Y of the first embodiment of the invention in respect of respectively having the ink ejection head 11 and the support plate 13, but are different from the head modules 12K, 12C, 12M and 12Y in that, similarly to a printing unit disclosed in JP-A No. 2003-246072, the nozzle surface N does not contact other members when positioning of each of the head modules 202 is performed.

In the printing unit 200 of the comparative example, the nozzle surfaces N are tilted because the nozzle surfaces N are not brought into contact with other members for positioning. Thus, the nozzle surfaces N of the ink ejection heads 11 are not aligned with respect to the image forming surface M, leading to problems such as misregistration of the color images.

In contrast, as shown in FIGS. 8A and 9B, in the printing unit 20 of the present embodiment, the nozzle surfaces N are aligned along the reference surface 84C of the reference plate 84 when positioning of the head modules 12 is performed. Thus, the nozzle surfaces N of the ink ejection heads 11 of the respective colors are aligned on the same plane with respect to the image forming surface M, whereby tilts of the nozzle surfaces N are prevented. As a result, the problems of misregistration and the like are prevented.

Further, in the printing unit 20 of the present embodiment, the sub-plate 17 is mounted on the mounting surface 19A of the carriage 19 (see FIG. 2B) such that the plural nozzle surfaces N aligned on the same plane are parallel to the image forming surface M, onto which droplets are ejected. Therefore, the position to which the ink of the printing unit 20 is ejected can be set to a desired position on the image forming surface M.

Moreover, in the ink ejection head positioning jig 70 of the present embodiment, since the frame member 75 is fixed to the sub-plate 17 at the three points, the support points of the sub-plate 17 are formed on the same plane. Thus, stable posture reproduction can be achieved without being affected by the accuracy of the plane of the sub-plate 17.

An alternative example of the ink ejection head positioning jig 70 in the first embodiment of the invention will be described next. The same reference numerals are used to designate parts that are the same as those in the first embodiment described above, and detailed description thereof will be omitted.

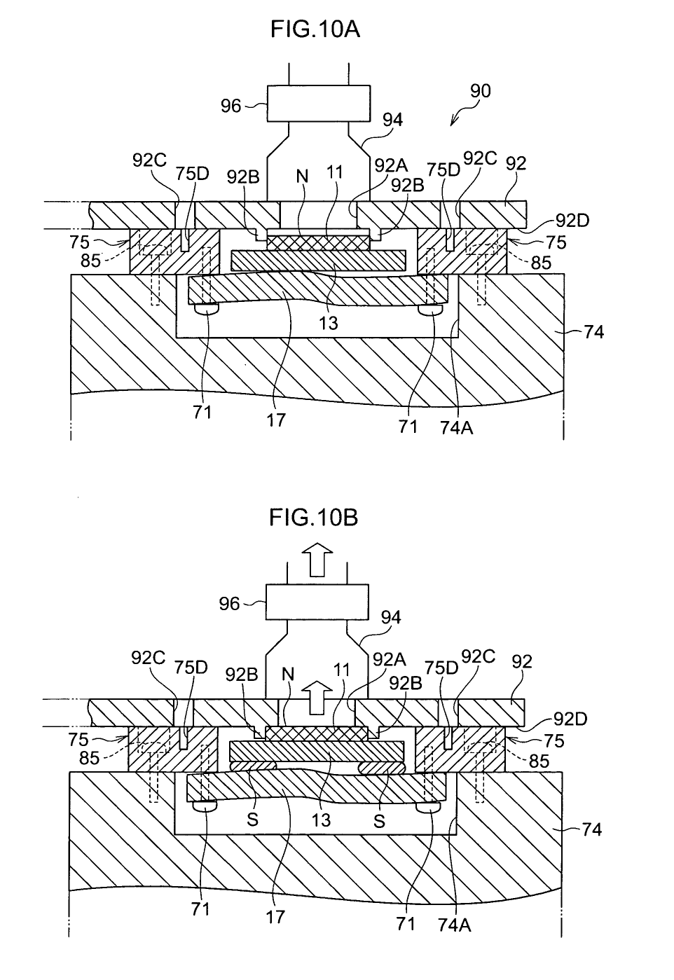

An ink ejection head positioning jig 90 is shown in FIG. 10A. The ink ejection head positioning jig 90 has a reference plate 92 in place of the reference plate 84 of the ink ejection head positioning jig 70 of the first embodiment, and further has an air suction duct 94 and a blower 96 for air suction.

A through hole 92A for air suction is formed in the center of the reference plate 92. The through hole 92A is smaller than the nozzle surface N of the ink ejection head 11. Further, a rib 92B protruding downward is formed at a reference surface (undersurface) 92D of the reference plate 92 around the through hole 92A, and the size of the rib 92B corresponds to the size of the ink ejection head 11. Furthermore, a through hole 92C is formed in the reference plate 92 at two positions further outward than the rib 92B, which positions correspond to the positions of the mounting holes 75D of the frame member 75. The air suction duct 94 is mounted around the through hole 92A at a side opposite to the side of the reference surface 92D such that no clearance is formed between the air suction duct 94 and the reference plate 92. The blower 96 is disposed around the air suction duct 94.

As shown in FIGS. 10A and 10B, in the ink ejection head positioning jig 90, the frame member 75 is fixed to the mount 74 after the sub-plate 17 is mounted to the frame member 75. Subsequently, the ink ejection head 11 and the support plate 13 are placed on the sub-plate 17, and the reference plate 92 is placed on the upper surface of the frame member 75 such that the ink ejection head 11 is disposed inside the rib 92B of the reference plate 92. When the blower 96 is operated in this state, negative pressure is generated and attracts the ink ejection head 11 and the support plate 13 toward the reference surface 92D, whereby the nozzle surface N contacts the reference surface 92D. In this way, an air suction means may be used to bring the nozzle surface N into contact with the reference surface 92D and retain the nozzle surface N thereon.

Next, a second embodiment of the head module, droplet ejection unit, image forming apparatus, droplet ejection head positioning jig, and method for manufacturing a head module in accordance with the invention will be described with reference to the drawings. The same reference numerals are used to designate parts that are basically the same as those in the first embodiment described above, and detailed description thereof will be omitted.

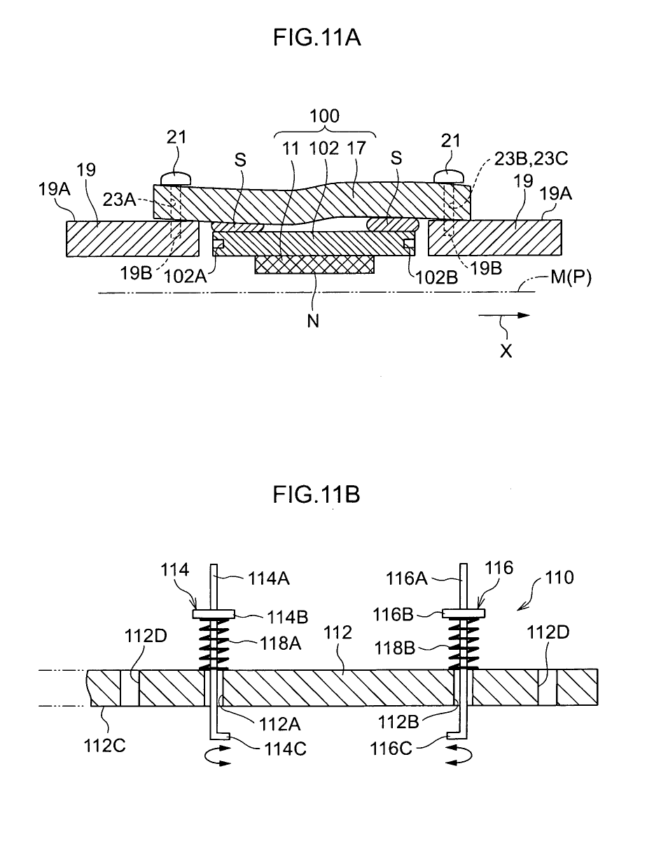

FIG. 11A shows a head module 100 according to the second embodiment. The head module 100 includes a support plate 102 in place of the support plate 13 of the head module 12 in the printing unit 20 of the first embodiment. Grooves 102A and 102B are formed at sides of the support plate 102.

FIG. 11B shows an ink ejection head positioning jig 110 according to the second embodiment. The ink ejection head positioning jig 110 includes a reference plate 112 having a reference surface (undersurface) 112C in place of the reference plate 84 of the ink ejection head positioning jig 70 of the first embodiment, and also includes hitching members 114 and 116, and coil spring members 118A and 118B.

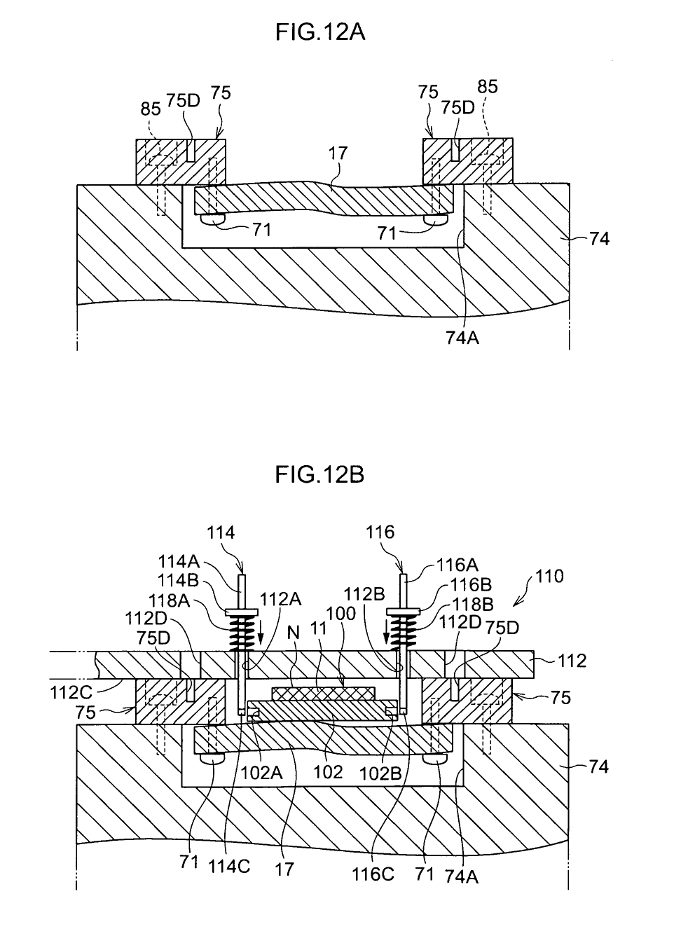

Through holes 112A and 112B are formed in the center of the reference plate 112 and spaced from each other. A through hole 112D is formed in the reference plate 112 at two positions at outer sides of the through holes 112A and 112B, which positions correspond to the positions of the mounting holes 75D of the frame member 75 (see FIG. 12B). The reference plate 112 is fixed in advance to the arm member 82 with the screws 81.

The hitching members 114 and 116 have the same structure and are formed by rod-shaped shanks 114A and 116A, plate-shaped flanges 114B and 116B respectively projecting from intermediate portions of the shanks 114A and 116A in radial directions thereof, and L-shaped hook portions 114C and 116C formed at ends (lower ends) of the shanks 114A and 116A, respectively. The hook portions 114C and 116C are inserted into the through holes 112A and 112B of the reference plate 112, respectively. Further, the spring members 118A and 118B are respectively fitted outside the shanks 114A and 116A between the flanges 114B and 116B and an upper surface of the reference plate 112 (i.e., the surface opposite to the reference surface 112C).

Operation of the second embodiment of the invention will be described next.

First, similarly to the first embodiment, the sub-plate 17 is mounted to the frame member 75, as shown in FIG. 12A. Subsequently, the sub-plate 17 and the frame member 75 are turned over and fixed onto the mount 74. The sub-plate 17 is disposed in the recess 74A formed at the mount 74.

Subsequently, as shown in FIG. 12B, the support plate 102 having the ink ejection head 11 fixed thereto in advance is placed on an upper surface of the sub-plate 17 and inside the frame member 75. The respective parts of the adjusting stage 80 (mainly the z-axis adjusting stage 79) are then moved to adjust the position of the reference plate 112, and the reference plate 112 is placed on the upper surface of the frame member 75 so as to cover the ink ejection head 11. At this time, the hook portions 114C and 116C of the hitching members 114 and 116, respectively, are rotated so as not to contact the support plate 102.

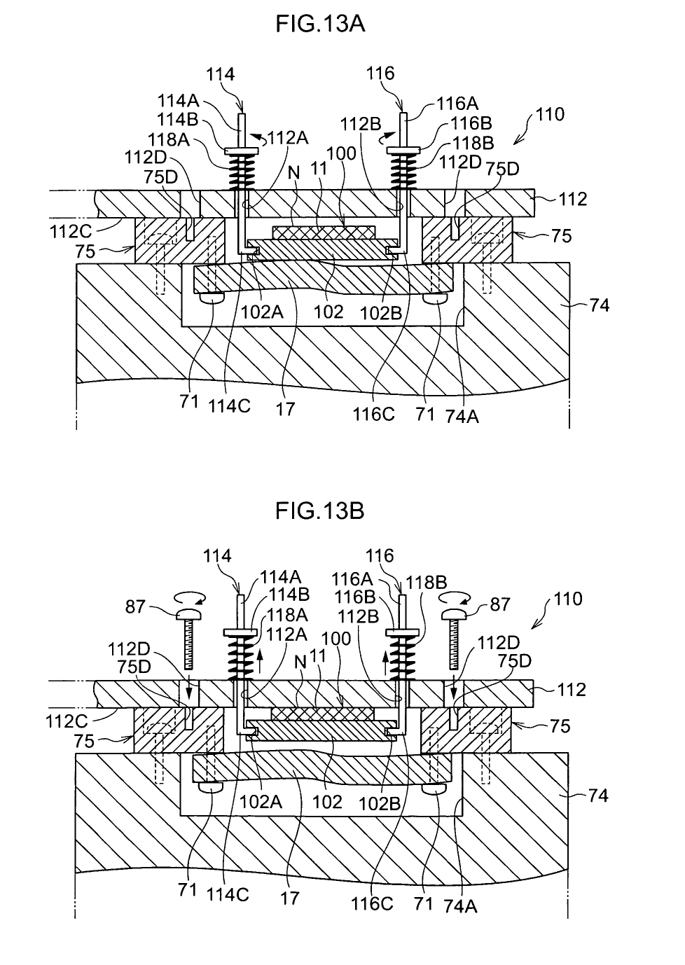

Subsequently, as shown in FIG. 13A, the flanges 114B and 116B of the hitching members 114 and 116 are pressed down while the hook portions 114C and 116C are rotated, such that the hook portions 114C and 116C engage with the grooves 102A and 102B, respectively.

At the time of this engagement, as shown in FIG. 13B, the flanges 114B and 116B are lifted by the restoring force of the spring members 118A and 118B that have been compressed, whereby the support plate 102 is lifted. As a result, the nozzle surface N of the ink ejection head 11 is brought into contact with the reference surface 112C of the reference plate 112. Further, the ink ejection head 11 and the support plate 102 are integrally retained.

Thereafter, while the ink ejection head 11 and the support plate 102 are retained, positioning of the ink ejection head 11 is performed using the x-axis adjusting stage 76, the y-axis adjusting stage 77 and the gonio-stage 78 of the adjusting stage 80 (see FIG. 4). After the reference plate 112 is fixed to the frame member 75 with the screws 87, the adhesive S is applied to a space between the support plate 102 and the sub-plate 17.

The adhesive S is hardened after the above steps are sequentially carried out on the respective ink ejection heads 11K, 11C, 11M and 11Y. Thereafter, the flanges 114B and 116B of the hitching members 114 and 116 are pressed down while the hook portions 114C and 116C are rotated, such that the hook portions 114C and 116C are disengaged from the grooves 102A and 102B, respectively. Then, the fixation screws 87 are removed to detach the reference plate 112, and the screws 71 are removed to detach the frame member 75. The steps of positioning and attaching the head module 100 are thus completed. Further, the sub-plate 17 is fixed to the carriage 19 (see FIG. 2B) with the screws 21, whereby the printing unit is completed.

In this way, by forming the grooves 102A and 102B at the sides of the support plate 102, the support plate 102 is fixed to the sub-plate 17 while the nozzle surfaces N of the plural droplet ejection heads are aligned on the same plane, which prevents tilts of the nozzle surfaces N.

A first alternative example of the ink ejection head positioning jig 110 according to the second embodiment of the invention will be described next. The same reference numerals are used to designate parts that are the same as those in the first and second embodiments described above, and detailed description thereof will be omitted.

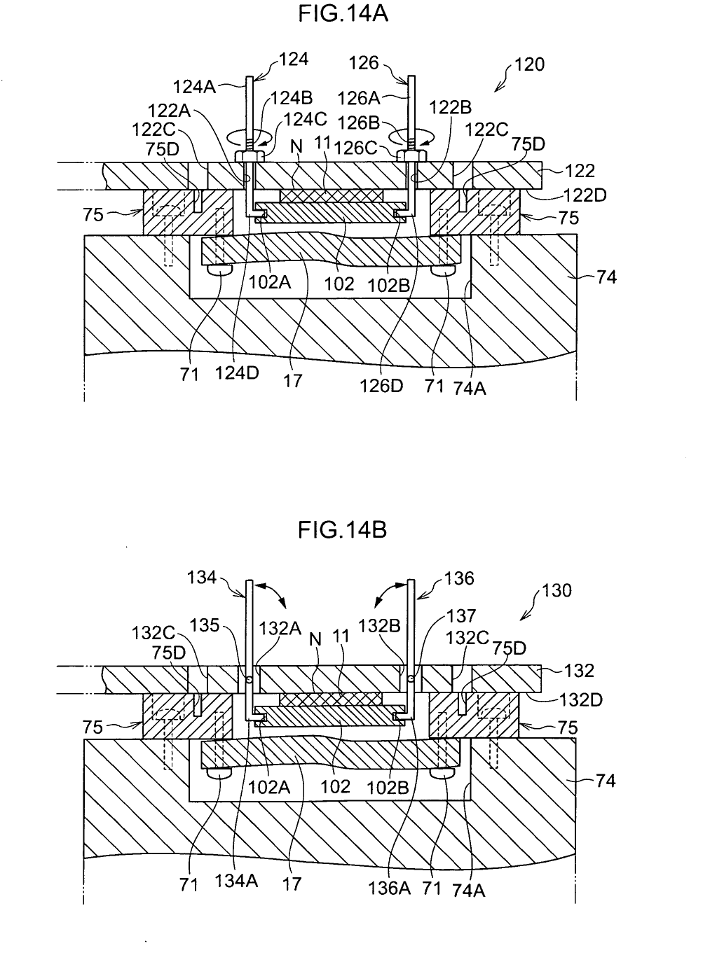

FIG. 14A shows an ink ejection head positioning jig 120. The ink ejection head positioning jig 120 includes a reference plate 122 in place of the reference plate 112 of the ink ejection head positioning jig 110 in the second embodiment, and further includes hitching members 124 and 126. The reference plate 122 has through holes 122C and a reference surface 122D.

The hitching members 124 and 126 have the same structure and are formed by rod-shaped shanks 124A and 126A, thread grooves 124B and 126B respectively formed at intermediate portions of outer peripheral surfaces of the shanks 124A and 126A, nut members 124C and 126C fitted on the thread grooves 124B and 126B, and L-shaped hook portions 124D and 126D formed at ends (lower ends) of the shanks 124A and 126A, respectively. The hook portions 124D and 126D are inserted into the through holes 122A and 122B, respectively, which are formed in the reference plate 122.

In the ink ejection head positioning jig 120, the frame member 75 is fixed to the mount 74 after the sub-plate 17 is mounted to the frame member 75. Subsequently, the ink ejection head 11 and the support plate 102 are placed on the sub-plate 17, and the reference plate 122 is placed on the upper surface of the frame member 75. Thereafter, the hook portions 124D and 126D are made to engage with the grooves 102A and 102B of the support plate 102, respectively, and the nut members 124C and 126C are tightened such that the nozzle surface N contacts the reference surface 122D. In this way, the hitching members 124D and 126D may be used to bring the nozzle surface N into contact with the reference surface 122D and retain the nozzle surface N thereon.

A second alternative example of the ink ejection head positioning jig 110 according to the second embodiment of the invention will be described next. The same reference numerals are used to designate parts that are the same as those in the first and second embodiments described above, and detailed description thereof will be omitted.

FIG. 14B shows an ink ejection head positioning jig 130. The ink ejection head positioning jig 130 includes a reference plate 132 in place of the reference plate 112 of the ink ejection head positioning jig 110 in the second embodiment, and further includes hitching members 134 and 136 in the shape of hinges. The reference plate 132 has through holes 132C and a reference surface 132D.

The hitching members 134 and 136 have the same structure and include hook portions 134A and 136A that are formed by bending ends (lower ends) of rod-shaped materials into substantial L-shapes. The hook portions 134A and 136A are inserted into the through holes 132A and 132B, respectively, which are formed in the reference plate 112. Further, central portions of the hitching members 134 and 136 are supported by support pins 135 and 137 at inner walls of the through holes 132A and 132B, respectively, and are rotatable in vertical planes.

In the ink ejection head positioning jig 130, the frame member 75 is fixed to the mount 74 after the sub-plate 17 is mounted to the frame member 75. Subsequently, the hook portions 134A and 136A are made to engage with the grooves 102A and 102B of the support plate 102, respectively, while the nozzle surface N contacts the reference surface 132D. The reference plate 132 is then placed on the upper surface of the frame member 75. In this way, the hitching members 134 and 136 in the shape of hinges may be used to bring the nozzle surface N into contact with the reference surface 132D and retain the nozzle surface N thereon.

The invention is not limited to the above embodiments.

Besides roll paper (continuous sheet paper), plural magazines for paper of different widths or qualities may be provided as an example of the sheet feed unit 16. Alternatively, in place of or in addition to the magazines for roll paper, the recording sheet P may be supplied by cassettes filled with stacked cut sheets.

Moreover, although the structure of the standard colors (four colors) of KCMY is exemplified in the embodiments of the invention, the combinations or number of the colors of inks are not limited to those described in the embodiments of the invention, and inks of light colors, dark colors or special colors may be added when needed. For example, the structure may be used in which an inkjet head for ejecting ink of light color such as light cyan or light magenta is added. Further, the order in which the respective heads are disposed is not limited to a particular one.

Furthermore, while the method in which the actuator represented by the piezoelectric elements is deformed such that ink droplets are ejected is used in the embodiments of the invention, the method for ejecting ink is not limited to a particular one. Various methods may be applied in place of the piezo jet method, such as a thermal jet method in which a heating element such as a heater heats ink so that air bubbles are generated, and ink droplets are ejected by the pressure of the air bubbles.

1. A head module comprising:
a droplet ejection head that has a nozzle surface on which a plurality of nozzles are formed and ejects droplets through the plurality of nozzles;
a support member to which the droplet ejection head is fixed; and
a sub-plate incorporated in a droplet ejection device and to which the support members are fixed with nozzle surfaces of droplet ejection heads being disposed on the same plane of a reference plate.

2. The head module according to claim 1, wherein a screw hole is formed in the support member, into which screw hole a screw for connecting the reference plate to the support member is inserted such that the nozzle surface is brought into contact with the reference plate.

3. The head module according to claim 1, wherein a groove for engagement with a hitching member provided at the reference plate is formed at a side surface of the support member such that the support member is moved toward the reference plate and the nozzle surface is brought into contact with the reference plate.

4. A droplet ejection unit having a mounting surface, to which the sub-plate of a head module is mounted such that the nozzle surface is parallel to a surface onto which droplets are ejected, wherein the head module comprises:
a droplet ejection head that has a nozzle surface on which a plurality of nozzles are formed and ejects droplets through the plurality of nozzles;
a support member to which the droplet ejection head is fixed; and
a sub-plate incorporated in a droplet ejection device and to which the support members are fixed with nozzle surfaces of droplet ejection heads being disposed on the same plane of a reference plate.

5. An image forming apparatus comprising:
a droplet ejection unit having a mounting surface, to which the sub-plate of a head module is mounted such that the nozzle surface is parallel to a surface onto which droplets are ejected, wherein the head module comprises:
a droplet ejection head that has a nozzle surface on which a plurality of nozzles are formed and ejects drop lets through the plurality of nozzles;
a support member to which the droplet ejection head is fixed; and
a sub-plate incorporated in a droplet ejection device and to which the support members are fixed with nozzle surfaces of droplet ejection heads being disposed on the same plane of a reference plate; and
a drive unit that drives the droplet ejection unit to eject droplets from the nozzle surface onto a recording medium such that an image is formed on the recording medium that has been conveyed to the surface onto which droplets are ejected.

6. A droplet ejection head positioning jig for positioning and fixing a support member to a sub-plate incorporated in a droplet ejection device, the support member having fixed thereto a droplet ejection head that has a nozzle surface on which a plurality of nozzles are formed and ejects droplets through the plurality of nozzles, the droplet ejection head positioning jig comprising:
a frame member;
a reference plate disposed on an upper surface of the frame member;
a retaining structure for retaining the support member and bringing the nozzle surface into surface contact with the reference plate; and
a movable stage for moving the reference plate.

7. The droplet ejection head positioning jig according to claim 6, wherein the retaining structure includes a screw that connects the reference plate to the support member.

8. The droplet ejection head positioning jig according to claim 6, wherein the retaining structure includes a hitching member provided at the reference plate to move the support member toward the reference plate, and a groove formed at a side surface of the support member and engaging with the hitching member.

9. The droplet ejection head positioning jig according to claim 6, wherein the retaining structure includes a negative pressure generating mechanism that generates negative pressure between the reference plate and the nozzle surface to bring the nozzle surface into contact with the reference plate.

10. The droplet ejection head positioning jig according to claim 6, wherein the frame member is fixed to the sub-plate at three points.

11. A method for manufacturing a head module that includes droplet ejection heads, each of which has a nozzle surface on which a plurality of nozzles are formed and ejects droplets through the plurality of nozzles, support members to which the droplet ejection heads are respectively fixed, and a sub-plate incorporated in a droplet ejection device and to which the support members are fixed, the method comprising:
disposing a plurality of nozzle surfaces on the same plane and positioning the support members with the support members being apart from the sub-plate; and
attaching the support members to the sub-plate after the positioning.

12. The method according to claim 11, wherein the positioning includes connecting a reference plate to the support members such that the nozzle surfaces contact the reference plate.

13. The method according to claim 11, wherein the positioning includes engaging a hitching member provided at a reference plate with a groove formed at a side surface of each of the support members, whereby the support members are moved toward the reference plate, and the nozzle surfaces are brought into contact with the reference plate.

14. The method according to claim 11, wherein the positioning includes generating negative pressure between a reference plate and the nozzle surfaces, whereby the nozzle surfaces are brought into contact with the reference plate.
